(19) United States
(12) Patent Application Publication
(10) Pub. No.: US 2004/0110113 A1
(43) Pub. Date: Jun. 10, 2004

(54) Tool and method of making a tool for use in applying a cosmetic

(76) Inventors: Alice Huang, San Jose, CA (US); Emilio E. Mercado, Mountain View, CA (US)

Correspondence Address: Milton S. Sales, Patent Legal Staff, Eastman Kodak Company, 343 State Street, Rochester, NY, 14650-2201, US

(21) Appl. No.: 10/315,630

(22) Filed: Dec. 10, 2002

(51) Int. Cl. G09B 19/00

(52) U.S. Cl. 434/100

(57) ABSTRACT

A tool and a method for creating a personalized tool illustrating the progressive stages of applying the cosmetic for use by a user. The method includes capturing a plurality of facial images of a face of user illustrating progressive stages of applying a cosmetic to at least one facial features of the user; identifying at least one facial feature; and providing the plurality of images of at least one facial feature of the user on a tool for illustrating the progressive stages of applying the cosmetic.

### FIELD OF THE INVENTION

The system uses a non-intrusive imaging capture during a reproducible process for the purposes to create a take-away tool that a customer can, at a later time, follow to reproduce the original process.

### BACKGROUND OF THE INVENTION

The present invention describes a system to enable consumers to have a personalized record of their professional cosmetic makeover. This record will be comprised of several images of the consumer taken during their professional makeover to give the consumer a step-by-step visual of how their makeup was applied. The consumer can then take this record home with them and repeat the makeover results with the aid of this personalized record.

The current practice for purchasing cosmetics in a sales-assisted environment (such as a department store or beauty salon) involves the sales assistant/cosmetic consultant/beautician selecting and applying cosmetics for a consumer. The consumer can look in a mirror occasionally during the makeup application, and the consultant will sometimes make notes as to what products were used and where they were applied. French Patent No. 1,297,337 has proposed presenting a style of makeup in front of the client on a pre-printed sketch roughly representative of the shape of the consumer's face, by directly applying makeup to desired locations on the sketch. However, selecting a predetermined type of face eliminates certain important aspects of a face's personality, and this method runs the risk of leading to a sort of uniformity in styles of makeup. The new invention described will image the consumer's own face.

U.S. Pat. No. 4,842,523 describes a method for making up a client characterized in that the method consists of projecting an image of the client's face onto a projection surface which has an opaque medium suitable for receiving makeup and for reproducing exact nuances thereof as when applied to skin and of disposing makeup on said projection surface in suitable locations to achieve a desired style of makeup. The makeup is not applied directly onto the client, but on the medium instead. The projection system described is also in plain view of the client.

U.S. Pat. No. 4,987,552 describes automatic editing equipment for compiling video makeup methods most suitable for each customer. It includes a memory medium receiving unit connected to a central processing unit and for receiving a plurality of memory media set every respective items or divisions of at least shape of face, eye, nose and mouth so as to cover features or looks of various persons and in which makeup methods are memorized in correspondence with various specifications in the respective items or divisions. A makeup method select circuit connected to the memory medium receiving unit makes comparisons between signals on the side of input information related to the form of face from individual customers and signals on the side of the memory medium receiving units, this to select makeup methods conforming to the input information from those in the plurality of memory media and combine them with each other. A video tape recorder is connected to the makeup method select circuit to automatically edit a videotape of the makeup method most suitable for each customer. The problem with this method is that the system performs a relative comparison of several of the customer's features to the existing memory media to determine which of the memory media the customer's features are closest to, but not necessarily exactly like. The existing memory media that most closely match the customer's features are then matched up with the corresponding pre-existing video taped makeup application instructions. One of the problems with this method is there is no record of the makeup application or makeup method performed directly on the customer's own face and features. Also, to view the compiled video, it is required that the customer use videotape players to view the makeup method instructions.

U.S. Pat. No. 6,293,284 B1 describes a method and apparatus for virtual makeover of a customer's face. A digital image is taken of the customer's face. Natural skin color is determined by a differential analysis among at least two different sites along the face to identify an area without color. The identified area without color is then used as a basis for projecting the customer's face with the natural skin color. Consultant's choice of preprogrammed color palettes matching the measured natural skin color is then projected on the facial image. The selected color palette can then be identified as a set of color cosmetic products which are provided to the customer. Problems not addressed by this invention are: there is no record of how the cosmetic or cosmetic colors actually looked once physically applied to the customer; colors of the cosmetics are also selected based on color analysis of the skin via an image, not the customer's actual skin; there are no instructions provided for how the customer is supposed to apply the makeup, the image capture process is traditional and obvious to the customer, or the customer must provide the image themselves.

U.S. Pat. No. 6,250,927 B1 describes a cosmetic application training system comprised of a substrate having facial image thereon, the facial image divided into multiple facial regions, and one or more transparent overlays having outlines of the facial image regions including printed instructions for applying makeup to each of the facial image regions; wherein the substrate is treated to permit application and removal of the makeup directly onto the substrate. Multiple pads with different facial region images are also contemplated, with removable facial region pieces being interchangeable. This training system is not personalized to represent the exact image of a customer, nor is it designed to provide a record of a customer's makeover when makeup is applied directly to that customer's face.

When a customer has a makeover done by a professional makeup artist, buys the makeup products and goes home, they have no personalized record of their own face that shows what was done. The present invention described in the following will address this problem.

### SUMMARY OF THE INVENTION

According to one aspect of the present invention there is provided a method for creating a personalized tool for use by a user, comprising the steps of:

a) capturing a plurality of facial images of a face of a user illustrating progressive stages of applying a cosmetic to at least one facial feature of the user;

b) identifying at least one facial feature; and

c) providing the plurality images of at least one facial feature of the user on a tool for illustrating the progressive stages of applying the cosmetic.

In accordance with another aspect of the present invention there is provided a system for creating a personalized tool for use by a user, comprising:

an image capture device for capturing a plurality of facial images of a face of a user illustrating progressive stages of applying a cosmetic to the at least one facial feature of the user;

a processing unit for identifying at least one facial feature; and

an output device for providing a plurality of images of at least one facial feature of the user on a tool for illustrating the progressive stages of applying a cosmetic.

In accordance with yet another aspect of the present invention there is provided a computer program such that when loaded onto a computer will cause a computer to perform the steps of:

a) obtaining a digital facial image of a user illustrating at least one stage in cosmetic application of the user; and

b) printing at least one feature of the digital facial image on a hardcopy media illustrating at least one stage.

These and other aspects, objects, features and advantages of the present invention will be more clearly understood and appreciated from a review of the following detailed description of the preferred embodiments and appended claims and by reference to the accompanying drawings.

### BRIEF DESCRIPTION OF THE DRAWINGS

In the detailed description of the preferred embodiments of the invention presented below, reference is made to the accompanying drawings in which:

FIG. 1a is a diagrammatic view illustrating a system for producing a tool in accordance with one embodiment of the present invention;

FIG. 1b is an illustration of customer/user using the system of FIG. 1 during the image capture procedure;

FIG. 1c is an illustration of customer during the optional addition of information to the tool;

FIG. 1d is an illustration of the front view of the imaging apparatus from the customer's point of view when looking directly at the imaging apparatus;

FIG. 2a is a logic flowchart for the process of creating a personalized tool for applying makeup for use by a user;

FIG. 2b is a subset logic flowchart for the image capture procedure as shown in FIG. 2a;

FIG. 2c is a subset logic flowchart for the tool producing method as shown in FIG. 2a;

FIG. 2d is a logic flowchart for the new image selection as shown in FIG. 2c;

FIG. 3 is an illustration of an embodiment of a completed tool made in accordance with the present invention; and

FIG. 4 is an illustration of progress images captured during a makeover in accordance with the present invention.

### DETAILED DESCRIPTION OF THE INVENTION

A system made in accordance with the present invention provides images of the client as they have makeup applied by a makeup artist in person, therefore providing them with an exact record of the event that they can later use as a tool to recreate the makeover process. The client can see how the makeup actually looked when put on their person, in various stages of the makeup application process, and use the tool provided for guidance to recreate the results thereafter. The makeup artist applying the makeup also has the ability to select makeup for the customer freely, without being forced into any predetermined menu of color palettes or methods for application of the makeup. The tool can be provided in a simple form so that the customer does not need any additional equipment to view the record of the event. The makeup artist or customer can, if they choose, also record written instructions for the makeup application for reference on the tool.

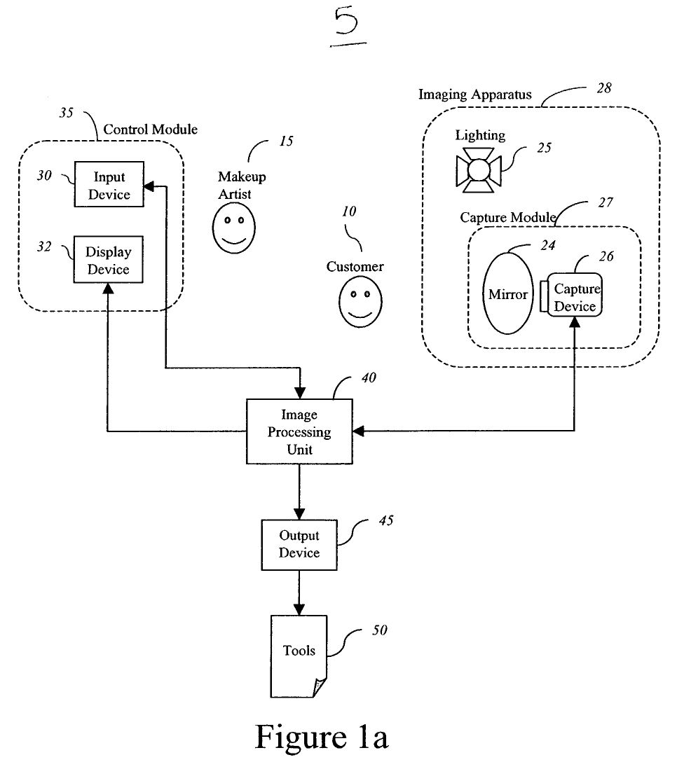

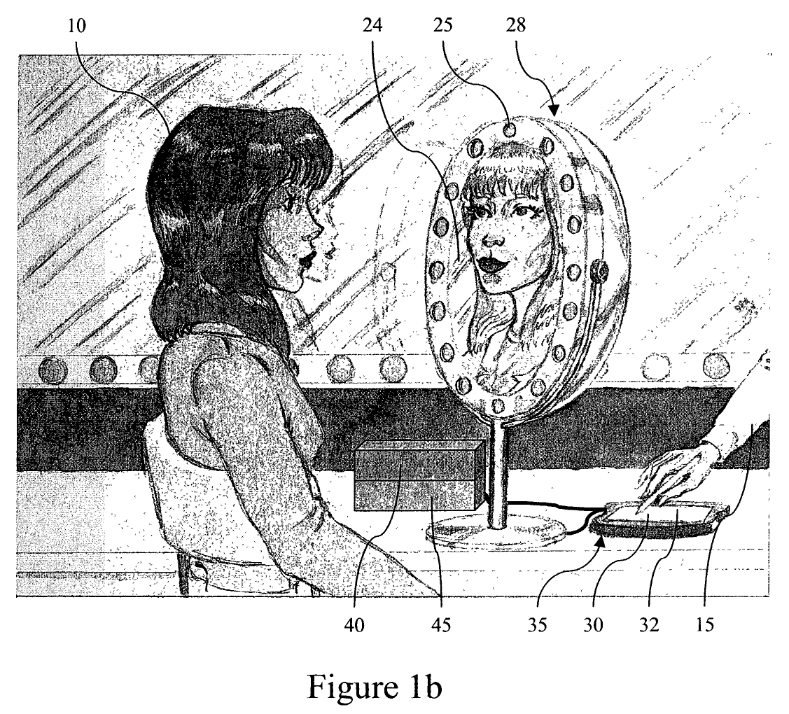

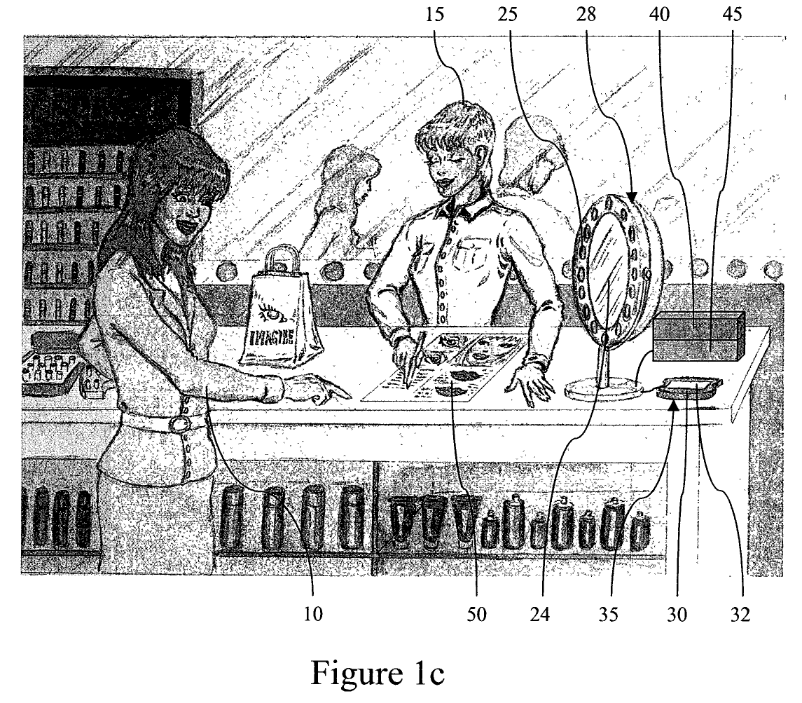

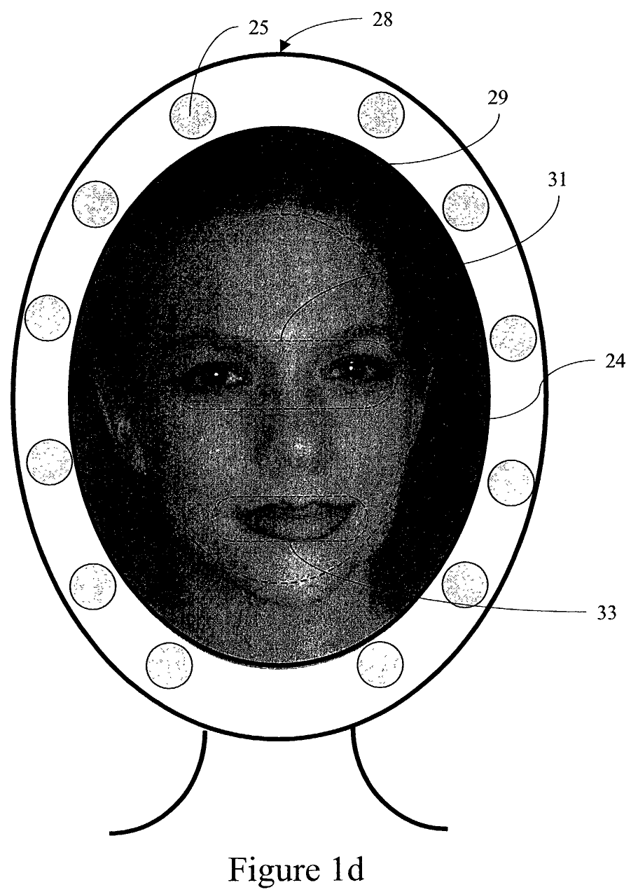

Referring to FIGS. 1a and 1b there is illustrated a system 5 made in accordance with the present invention. The system 5 includes an imaging apparatus 28 for viewing and capturing images of a customer 10. The imaging apparatus 28 includes a mirror 24 for viewing of the customer 10 and an image capture device 26 for capturing digital images of the customer 10 during the makeover process. Preferably the image capture device 26 is enclosed behind the mirror 24 creating a capture module 27, so that the customer 10 will see only their own reflection in the mirror 24 and not be overly aware of the image capture device 26 or be distracted. In the particular embodiment illustrated in FIGS. 1a and 1b, the image capture device 26 is a digital camera, such as a Kodak LS 420, however any suitable image capture device may be employed such as a video camera, CCD or CMOS censor. The imaging apparatus 28 also includes a lighting system 25 for illuminating the customer 10 positioned at the capture device 26.

Preferably the lighting system 25 is mounted around the mirror 24 to ensure proper lighting of the customer 10 at capture, so the lighting system 25 and capture module 27 are combined to create one imaging apparatus 28. In the illustrated embodiment, the lighting system 25 comprises a plurality of individual lamps around the periphery of the mirror 24. However, the lighting system 25 may be comprised of any lighting configuration such as overhead ceiling lighting, separate counter-top lighting fixtures, or flash lighting. It is desirable that the lighting be adjustable to different wavelengths so the customer 10 could view themselves under different conditions, such as natural outdoor, fluorescent, or incandescent lighting. It is also possible to use the most optimal lighting conditions and then apply an image algorithm to the image to make it look like the image was taken under certain lighting conditions such as natural outdoor, fluorescent or incandescent. Such algorithms used to digitally change the lighting of an image are well known to those skilled in the art.

It is also desirable that the capture device 26 be located behind the mirror 24 so the customer 10 could view themselves during the process while not being distracted. The mirror 24 could be a one-way mirror or reflective privacy glass so the image capture device 26 can capture the image of the customer 10, but the customer 10 is not distracted by seeing the image capture device 26 in plain view.

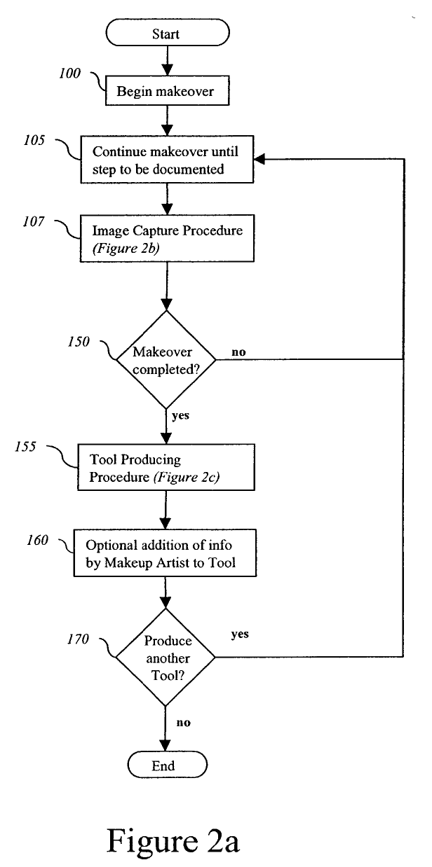

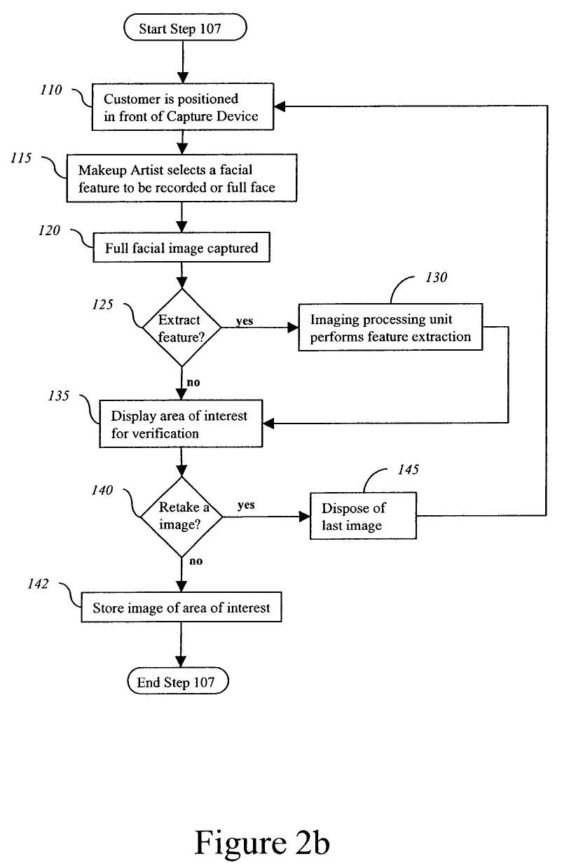

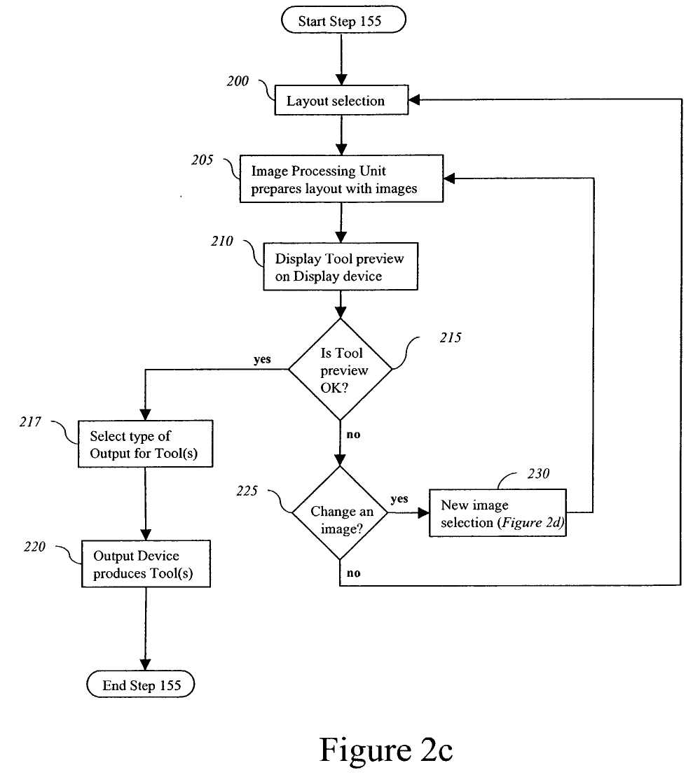

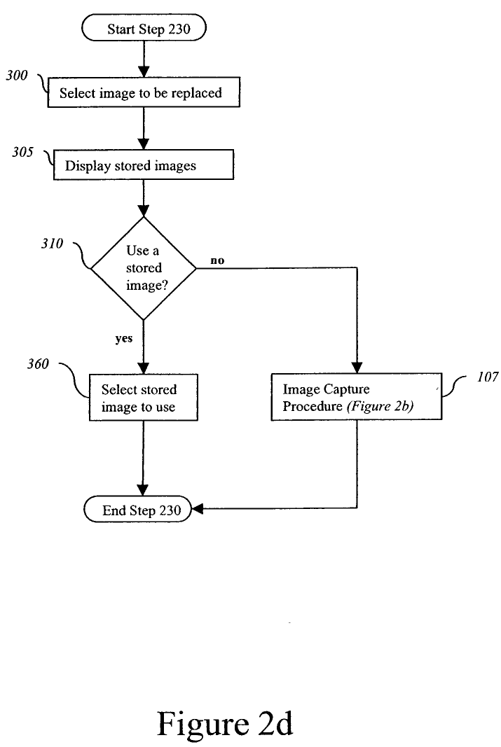

Referring to FIG. 1d, which is an illustration from the customer's 10 point of view when looking directly at the imaging apparatus 28. In this embodiment, the lighting 25, mirror 24, and image capture device 26 (not shown) have been integrated into the imaging apparatus 28. In addition, fiducial marks (framing marks) 29, 31, 33, have been added in this embodiment to facilitate the later extraction of areas of interests from the captured image. This process will be later explained as part of the capture process in FIG. 2b.

Continuing with the description of the system 5 illustrated in FIGS. 1a and 1b, an input device 30 is provided so that so that the makeup artist 15 or any operator uses to send commands to the image processing unit 40. The display device 32 shows the information and command options from the image processing unit 40. In this particular embodiment, the control module 35 is a touch screen pad that combines the input device 30 and the display device 32 where information from the image processing unit 40 is shown. However any type of input device and display device combination could be used, such as a wired or wireless keyboard, personal digital assistant (e.g. Palm VII), pressure sensitive tablet (e.g. WACOM tablet) or mouse, combined with any type of display such as a cathode ray tube (CRT), plasma, liquid crystal display (LCD) or organic light emitting diode (OLED) display in any type of configuration.

The image processing unit 40 in the embodiment illustrated is a computer that controls the actions of the capture device 26, receives the images from the capture device 26, applies algorithms to the images, and transmits and receives information back and forth from the input device 30 and the display device 32. The image processing unit 40 also creates and sends information to the output device 45 for the creation of the tools. In this particular embodiment, the image processing unit 40 is a personal computer, however any type of device with memory, processing power, input and output capabilities can be employed, such as a laptop computer or personal digital assistant (PDA).

The output device 45 receives information from the image processing unit 40 and delivers a copy of the tool 50. In this particular embodiment, the output device 45 is a high quality inkjet printer, but any output-producing device can be used, such as a thermal printer, CD writer, email server, or floppy disc writer. It is to be understood that the tool 50 can be made in a variety of formats so long as it is capable of displaying the images either in a hard copy format or an electronic format that can be used to display images on a display device.

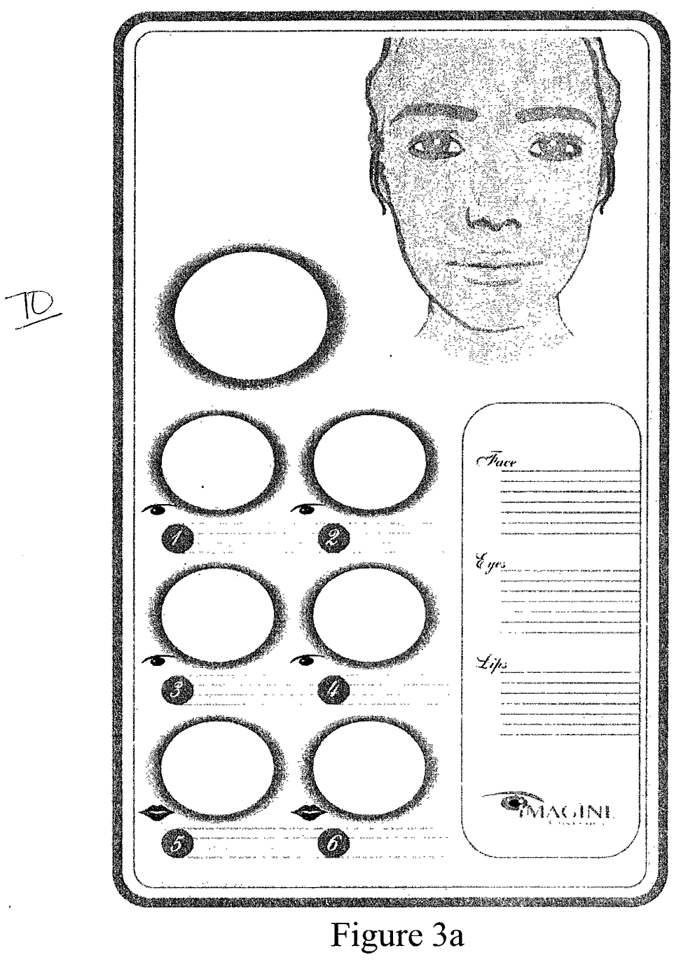

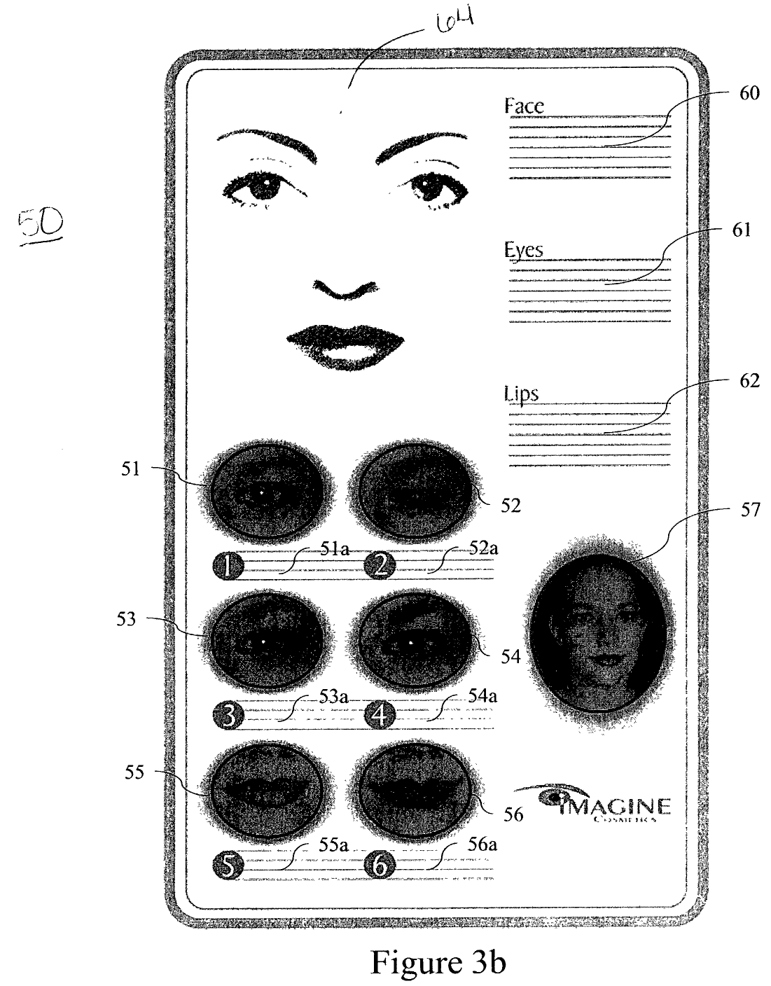

Referring to FIG. 1a, the tool 50 is produced according to information passed on from the image processing unit 40. An example of various tools 50 made in accordance with the present invention are shown in FIG. 1c, and FIG. 3b. Each tool 50 is composed of the customer's 10 images captured during the makeover and processed by the image processing unit 40 to the specifications input via the input device 30 by the makeup artist 15. In the current embodiment, the tools 50 are an inkjet hardcopy printout, but can be any form of record, such as a thermal printout, file copy on CD, file copy on floppy disc, or electronic mail file. Briefly, a tool 50 made in accordance with the present invention provides a plurality of images of the client illustrating successive images as the make over process progresses. Often the tool 50 will also include various instructions and/or information with each image.

In other embodiments, any of the aforementioned components of the system 5 could be separate or combined differently in one or more components.

Using the system 5 as described in FIG. 1a, a tool 50 is created while the customer 10 waits, so the customer 10 can use the tool 50 to help guide them in recreating the makeover results at home, or anytime after the makeover is completed. An example of the environment as shown in FIG. 1c in which the method by FIG. 2a could occur is a department store cosmetic department, where there are branded cosmetic counter stations manned by professionally trained cosmetic consultants and makeup artists. Samples of each brand's cosmetics are available for customers to try themselves to see if they like the product, and for the cosmetic consultants and makeup artists to demonstrate the products to potential customers. Mirror, chairs, application tools and appropriate lighting are also provided, creating a comfortable and suitable environment for trying on cosmetic products. Makeovers are a routinely employed as a selling tool by cosmetic consultants and makeup artists as a means to demonstrate and recommend products to customers. Makeovers are also routinely requested by customers as a means to learn what cosmetic products to use and how to properly apply them to their own features and needs. A common problem that occurs is that after the professionally trained cosmetic consultant or makeup artist completes a makeover for the customer, the customer is faced with the challenge of remembering how to use the demonstrated products to recreate the results of the makeover. The present invention will addresses this problem, describing a preferred embodiment in which the method illustrated by FIG. 2a could be employed.

In order to better understand the present invention, a discussion of one method for making a tool 50 in accordance with the present invention will be 10 described. Referring to FIG. 2a there is illustrated a flow chart for making a tool 50. The customer 10 first agrees to have makeup applied in a makeover done by a skilled makeup artist 15 and makeover process begins at step 100. The customer 10 also agrees to have a series of images taken to create a customized tool 50 capturing steps of the makeover process with their own images while the makeup is being applied to their own face. The makeup artist 15 may remove any current makeup on the customer 10 and then begin the makeover at step 100 by applying new makeup to the customer's face. Note that an image of the customer 10 without any makeup can also be recorded if desired. The makeup artist 15 decides when to pause to capture an image documenting a stage in the makeover at step 105.

The image capture procedure 107 produces an image of the area of interest that the makeup artist 15 wants to record at this point. This process will be discussed in further detail later in FIG. 2b.

A decision step 150 is made to determine if the makeover process has been completed. If the makeover process is not complete, steps 105 and 107 are repeated until the makeup artist 15 completes the makeover.

When the makeover is completed at step 150, the makeup artist 15 will indicate so via the input device 30. The makeup artist 15 then begins to produce a tool 50 at step 155. FIG. 2c illustrates the method for producing tools at step 155, which will be later discussed in further detail in FIG. 2c.

Once the tool 50 is produced, the makeup artist 15 can discuss the tool 50 with the customer 10 and has the option of adding additional information if desired at step 160 such as but not limited to, handwritten notes, prewritten notes, typed comments, product stickers, pictures, brochures or any other sort of information relevant or related to the makeover, products and processes in FIGS. 2a, 2b, 2c or 2d. The makeup artist 15 then delivers the tool 50 to the customer 10. The customer 10 either receives the tool(s) 50 as a complimentary product or is charged in a way that the makeup artist 15 and the makeup artist's employers deem appropriate.

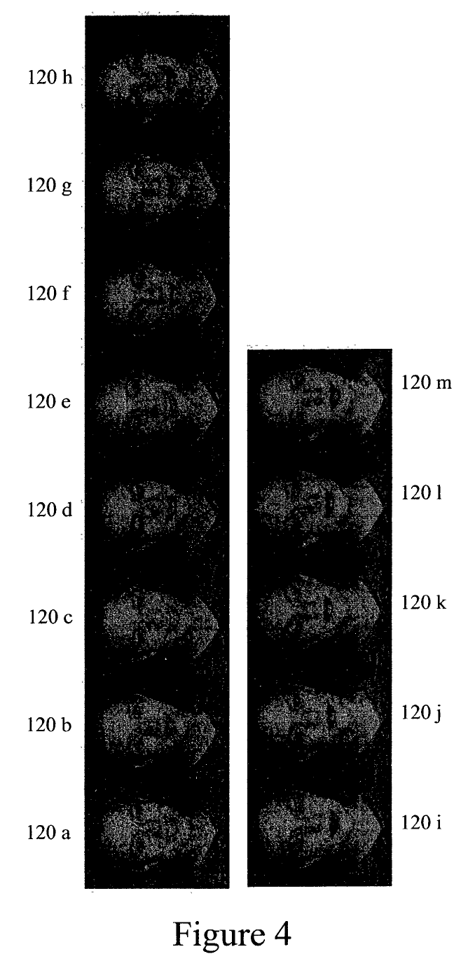

Finally, the makeup artist 15 can decide whether or not to produce another tool 50 for the customer 10 at step 170. If another tool is desired, the makeover process will continue at step 105 and the necessary steps repeated until another tool 50 is produced at step 155. An example of this situation would be where a customer 10 desired a tool 50 be produced at step 155 when the “everyday” makeover was completed, as illustrated in FIG. 4 image 120i; and then desired another tool 50 be produced as the makeover is continued starting with step 105 to produce an “evening” look as illustrated in FIG. 4, image 120m.

Referring to FIG. 2b, is illustrated in greater detail the various steps involved in the image capture procedure 107. The customer 10 is positioned in front of the imaging apparatus 28 at step 110. To assure proper positioning of the customer 10 relative to the capture device 26, a method could be implemented such as outlining an area on the capture module's 27 one-way mirror 24 for the customer 10 to position herself in. For example, the mirror 24 could have an outline or etching such as an oval, or have other markings on it to help align the customer's 10 position relative to the capture device 26. Referring to FIG. 1d, which illustrates an elevation view of a mirror 24 having fiducials (framing marks) 29, 31, and 33. Fiducial 29 provided a general outline of the face. The client need only align her/his face until it substantially fills the fiducial 29. Fiducial 31 identities the area in which the eyes should be positioned and fiducial 33 identifies the general area where the mouth is preferably positioned. It is to be understood that any one fiducial or combination thereof may be used for positioning the customer 10 in the mirror 24 so that the facial features can be easily identified by image processing unit 40. The makeup artist 15 would ask the customer 10 to look at their face in the mirror 24 and position themselves so the reflection of their face filled the area marked on the mirror 24. This would assure consistent alignment and focal length between the customer's 10 face and the capture device 26 for the image capture procedure at step 107.

The makeup artist 15 at step 115 uses the control module 35 to select the facial feature to be photographed, choosing from options such as full face, left eye, right eye, lips, cheek areas or any other facial region. This selection triggers the capture device 26 to take a digital image of the customer's 10 full face at step 120. Any combination of the imaging apparatus 28 components can be used, however in this preferred embodiment, the image capture action is unnoticeable to the consumer 10 because the imaging apparatus 28 allows for the capture device 26 to be hidden from plain sight, and the lighting 25 provides constant ideal illumination so no additional lighting, such as a flash, is required. The captured image is then sent to the image processing unit 40.

At step 125, if the makeup artist 15 selected to extract a feature at step 115 then the image processing unit 40 performs the extraction process at step 130. Examples of facial features may comprise any one of combination of the following: lips; single eye; eyes; cheeks; forehead; nose or any other physical feature. One embodiment of this step is a manual approach in which the makeup artist 15 explicitly identifies the areas of interest from the full face image capture on the display device 32, and the image processing unit 40 performs the corresponding cropping of the captured image to isolate the area of interest. If the client has been positioned with respect to the fiducials 29, 31, 33 on the mirror 24, then the capture device 26 knowing the relationship of the fiducials 29, 31, 33 can easily identify and determine the facial area containing the selected facial feature. In another embodiment for step 130 an automatic algorithm can be used to analyze the image and extract the selected facial feature. An example of such algorithm is described by A. Lanitis, C. J. Taylor, and T. F. Cootes, “Automatic Interpretation and Coding of Face Images Using Flexible Models,” IEEE Trans. on PAMI, Vol. 19, No. 7, pp. 743-756, 1997, which is incorporated herein by reference.

If the full face capture was selected in step 115, no feature extraction is performed and the full face image captured at step 120 is displayed as the area of interest at step 135.

At step 135, the area of interest, full face or extracted facial feature, is shown on the display device 32 for verification. The makeup artist 15 assesses the image and decides whether to save or retake the image at step 140. If the image of the area of interest is not acceptable, the makeup artist 15 can choose to retake an image at step 140. In this case, the image processing unit 40 will dispose of the image (both captured and/or the selected area of interest) at step 145, and the image capture process begins again at step 110 until an acceptable image is obtained. If the image of the area of interest is acceptable, the image processing unit 40 will store the image of the area of interest at step 142 which will later be accessed to create the tools 50 and completes the image capture procedure 107.

Referring to FIG. 2c there is illustrated in detail the various steps that are involved in the tool producing procedure 155 of FIG. 2a. At step 200 a layout is selected by the makeup artist 15. Referring to FIG. 3a an example of a layout 70 is illustrated. For the purposes of this description, a layout 70 is defined as the arrangement of images, illustrations, text and any other information that the tool 50 is comprised of. There are numerous ways in which the layouts 70 can be provided for selection at step 200 which may include, but is not exclusive to the following:

a) the image processing unit 40 is preloaded with layout 70 configurations and selects the layout 70 that best suits the number and type of images stored at step 142;

b) the makeup artist 15 selects from a number of preloaded layout 70 configurations based on the customer's 10 requests, or the makeup artist's 15 judgment;

c) the image processing unit 40 is preloaded with one default layout 70 configuration;

d) the makeup artist 10 manually selects the layout 70 of the images and inputs it into the image processing unit 40 via the control module 35; and/or

e) some combination of the above.

At step 205 the image processing unit 40 prepares a tool 50 comprised of the stored images of the areas of interest from step 142. The image processing unit 40 renders a preview of the tool 50 and displays the preview on the display device 32 at step 210. The makeup artist 15 and/or the customer 10 decide if the preview of the tool 50 shown at step 210 is acceptable or not at step 215. The processing unit 40 may also perform one of the following steps:

a) image cropping based on the area of interest identifier;

b) image analysis for measurements;

c) resizing; and

d) compositioning with overlays.

If the tool 50 preview is not acceptable at step 215, then at step 225, the makeup artist 15 and/or customer 10 decide(s) if they want to change an image shown on the tool 50 preview in step 215. If it is decided at step 225 that an image shown on the tool 50 preview at step 215 should be changed then a new image is selected by the process in step 230. This process is explained in further detail with FIG. 2d.

Once a new image is selected at step 230, the image processing unit 40 prepares a new layout with the new set of images at step 205. The preview of the tool 50 is shown on the display device 32 at step 210 until the preview of the tool 50 is acceptable. In the instance where the tool 50 preview is not acceptable in step 215, but there is no desire to change an image 225, the makeup artist will then be given the option to select a new layout 70 for the tool 50. To accomplish this, the makeup artist 15 and/or customer 10 decide what the new layout 70 of the tool 50 at step 200 should be, by viewing options on the display device 32 and inputting information via the input device 30. It is to be understood that the layouts 70 selection at step 200 may be accomplished by a variety of methods, for example, but not limited to the following:

a) the image processing unit 40 chooses another layout 70 option from preloaded layout 70 configurations;

b) the makeup artist 15 selects from a number of preloaded layout 70 configurations based on the customer's 10 requests, or the makeup artist's 15 judgment;

c) the image processing unit 40 is preloaded with one default layout 70 configuration;

d) the makeup artist 15 creates the layout 70 of the images and inputs it into the image processing unit 40;

e) the makeup artist 15 changes the positioning of any of the images within the layout 70; and

f) any combination of a, b, c and d.

Once a new layout 70 is selected at step 200, the image processing unit 40 will prepare a preview of the new tool 50 at step 205, and it will be shown on the display device 32 for verification at step 210.

Once the preview of the tool 50 is determined to be acceptable at step 215, the makeup artist 15 selects the desired type of output of the tool 50 at step 217 and sends the selection(s) to the image processing unit 40 via the input device 30. At step 220, the image processing unit 40 sends the information to create the tool 50 to the output device 45 and the tool(s) 50 are generated. This completes the tool producing process step 155.

Referring to FIG. 2d the process of new image selection at step 230 is illustrated. The image to be replaced is selected at step 300. The image processing unit 40 then sends the stored images to the display device 32 at step 305. The makeup artist 15 and/or customer 10 decides at step 310 whether or not to use one of the stored images displayed at step 305. If a stored image is to be used, the selection of which image to use is made at step 320. If not, a new image can be taken by following the image capture procedure at step 107.

The output device 45 can be capable of producing many types of tools 50, which may include but are not exclusive to the following:

a) hardcopy printed material;

b) electronic file on CD, floppy; or

c) transmission (such as in an email.)

Referring to FIG. 3b is an illustration of an example of a tool 50 made in accordance with present invention provided in hardcopy format. In the particular embodiment illustrated in FIG. 3b, tool 50 includes a plurality of image areas 51, 52, 53, 54, 55, 56 and 57. Image areas 51, 52, 53 and 54 illustrated four progressive stages of the make over of the eye region of the customer's 10 face. Only one eye region is illustrated, as typically both eyes would be done in the same manner. Image areas 55 and 56 illustrate two stages of the lip region of the face and image area 57 show the completed full face of the customer 10. Associated with each image area 51, 52, 53, 54, 55, and 56 is a text area 51a, 52a, 53a, 54a, 55a, and 56a respectively, provided for notes, information and/or instructions with respect to the associated image. Typically these text areas would include the necessary instruction to arrive at the illustrated stage. In the embodiment illustrated tool 50 also is provided with text areas 60, 61, and 62 for providing notes with respect to various facial features, for example, face, eyes and lips as illustrated. Illustration 64 is an example of an illustration that could be included in the tool 50 unto which actual cosmetics can be applied to demonstrate their color and/or placement. While in the embodiment illustrated only specific facial features are illustrated in progressive stages, the entire face or any other combination of facial features can be selected and present in any desired layout 70 and in any desired format.

Referring to FIG. 4 there is illustrated a series of images 120a to 120m representing different stages that could be recorded during the makeover process referred to in FIG. 2a. For example, image 120a shows the customer 10 without any makeup on when the makeover begins, illustrating FIG. 2a step 100. Image 120d shows the customer 10 with foundation, eye shadow and eyeliner applied. Image 120e shows detail with the customer's 10 eyes closed; image 120f shows detail with the customer's eyes opened. This is important so the customer will be able to see how the makeup was applied by capturing at different angles of the eyes.

Referring to FIG. 3b the example of a printout of a tool 50 a customer 10 uses the it by taking it home and referring to it at a later time in an attempt to recreate the makeover results. By taping a printout of a hardcopy of a tool 50 to the customer's 10 bathroom mirror, the customer 10 can follow the steps outlined and illustrated on the tool 50 and apply the cosmetics in a manner similar to have their were applied during the makeover.

The invention has been described in detail with particular reference to certain preferred embodiments thereof, but it will be understood that variations and modifications can be effected within the scope of the present invention.

### PARTS LIST

5 System

10 Customer

15 Makeup artist

24 Mirror

25 Lighting

26 Capture device

27 Capture module

28 Imaging apparatus

29 Fiducial mark for full face

30 Input device

31 Fiducial mark for eyes

32 Display device

33 Fiducial mark for lips

35 Control module

40 Image processing unit

45 Output device

50 Tools

51 Image area

51a Text area for part 51

52 Image area

52a Text area for part 52

53 Image area

53a Text area for part 53

54 Image area

54a Text area for part 54

55 Image area

55a Text area for part 55

56 Image area

56a Text area for part 56

57 Image area

60 Text area for face

61 Text area for eyes

62 Text area for lips

64 Illustration for makeup demonstration

70 Layout

100 Step

105 Step

107 Step

110 Step

115 Step

120 Step

120a-120m Image

125 Step

130 Step

135 Step

140 Step

142 Step

145 Step

150 Step

155 Step

160 Step

170 Step

200 Step

205 Step

210 Step

215 Step

217 Step

220 Step

225 Step

230 Step

300 Step

305 Step

310 Step

320 Step

What is claimed is:

1. A method for creating a personalized tool for use by a user, comprising the steps of:
a) capturing a plurality facial images of at least one face feature of user illustrating progressive stages of applying a cosmetic to said at least one facial feature of said user; and
b) providing said plurality images of said at least one facial feature of said user on a tool for illustrating said progressive stages of applying said cosmetic.

2. A method according to claim 1 further comprising the step identifying said at least one facial feature;

3. A method according to claim 2 wherein a processing unit automatically identifies said at least one facial feature.

4. The method according to claim 1 further comprising the step of:
providing instructions/information adjacent said plurality of images on said tool.

5. The method according to claim 1 wherein said tool comprises a hard copy print.

6. The method according to claim 5 wherein instructions are associated with each of said plurality of images.

7. The method according to claim 1 further comprising the step of:
positioning said user such that the face of said user is located relative to a capture device used for capturing said facial images.

8. The method according to claim 7 further comprising the step of:
providing a mirror of a predetermined configuration that can be used for aligning said user with respect to said capture device.

9. The method according to claim 1 where said at least one facial feature comprises a full facial image.

10. The method according to claim 1 where said at least one facial feature comprises a single facial feature.

11. The method according to claim 10 wherein said at least one facial feature is selected from one of the following:
lips;
eye;
eyes;
cheeks;
forehead; and
nose.

12. The method according to claim 1 wherein said tool comprises a digital file.

13. The method according to claim 1 wherein said tool comprises a computer disc.

14. The method according to claim 1 wherein said tool comprises an electronic format that can be used to display images on a display device.

15. The method according to claim 1 wherein said capturing of said facial images comprises the step of approving each image captured and retaking the facial image until acceptable facial image is obtained.

16. The method according to claim 15 said accepted facial image is stored in an image processing unit.

17. The method according to claim 1 wherein said image processing unit prepares a selected lay out of said tool.

18. The method according to claim 17 where said processing unit performs one for the following steps:
image cropping based on the area of interest identifier;
image analysis for measurements;
resizing; and
compositioning with overlays.

19. The method according to claim 1 further comprising the step of:
selecting a layout for said tool.

20. The method according to claim 19 wherein various layouts are viewed until an acceptable layout is found.

21. The method according to claim 1 wherein a makeup artist controls capturing of said plurality of images.

22. The method according to claim 1 wherein a makeup artist controls the selection of the output layout.

23. A system for creating a personalized tool for use by a user, comprising:
an image capture device for capturing a plurality images of at least one facial feature of said user illustrating progressive stages of applying a cosmetic to said at least one facial features of said user;
a processing unit for identifying said at least one facial feature; and
an output device for providing said plurality images of said at least one facial feature of said user on a tool for illustrating said progressive stages of applying said cosmetic.

24. A system according to claim 23 further comprising a mirror that can be used to hide said capture device with respect to said user.

25. A system according to claim 23 further comprising a mirror having markings thereon that can be used to align the user with respect to said capture device.

26. A system according to claim 23 wherein said processing unit is used to identify individual facial features of said user.

27. A system according to claim 23 further comprising lighting for illuminating the user during image capture.

28. A system according to claim 27 wherein said lighting is placed around the periphery of the mirror.

29. A system according to claim 24 wherein said image capture device and said mirror comprises a single device.

30. A system according to claim 23 wherein said single device further includes lighting for illumination of said user during image capture.

31. A system according to claim 28 wherein said lighting comprises a plurality of lights provided around the periphery of said mirror.

32. A computer program such that when loaded onto a computer will cause a computer to perform the steps of:
a) obtaining a digital facial image of a user illustrating at least one stage in cosmetic application of said user; and
b) printing at least one feature of said digital facial image on a hardcopy media illustrating said at least one stage.

33. The computer program according to claim 32 further comprising the step of:
identifying said least one facial feature;

34. The computer program according to claim 33 wherein a processing unit automatically identifies said at least one facial feature.

35. The computer program according to claim 32 wherein said computer program automatically extracts said at least one feature.

36. The computer program according to claim 35 further comprising the step of:
providing instructions/information adjacent said plurality of images on said tool.

37. The computer program according to claim 32 wherein said tool comprises a hard copy print.

38. The computer program according to claim 32 wherein instructions are associated with each of said plurality of images.

39. The computer program according to claim 30 where said facial image comprises a full facial image.

40. The computer program according to claim 32 wherein said facial images comprises a single facial feature.

41. The computer program according to claim 40 wherein said facial feature is selected from one of the following:
lips;
eye;
eyes;
cheeks;
forehead; and
nose.

42. The computer program according to claim 32 wherein said tool comprises a digital file.

43. The method according to claim 32 wherein said tool comprises an electronic format that can be used to display images on a display device.

44. The method according to claim 32 wherein said capturing of said facial images comprises the step of:
approving each image captured and retaking the facial image until acceptable facial image is obtained.

45. The method according to claim 44 said accepted facial image is stored in an image processing unit.

46. The method according to claim 45 wherein said image processing unit prepares a selected lay out of said tool.

47. The method according to claim 46 where said processing unit performs one of the following steps:
image cropping based on the area of interest identifier;
image analysis for measurements;
resizing; and
compositioning with overlays.
